(19) United States
(12) Patent Application Publication
(10) Pub. No.: US 2012/0159538 A1
(43) Pub. Date: Jun. 21, 2012

(54) TARGETED ADVERTISING BASED ON USER AUTHENTICATION, DEMOGRAPHICS AND USER SELECTION

(76) Inventors: Chris Phillips, Hartwell, GA (US); Charles Dasher, Lawrenceville, GA (US)

(21) Appl. No.: 12/968,969

(22) Filed: Dec. 15, 2010

(51) Int. Cl. H04N 7/025

(52) U.S. Cl. 725/34

(57) ABSTRACT

Methods of delivering a time shifted video program include obtaining an individualized advertisement preference for a viewer of the time shifted video program, selecting an advertisement from among a plurality of available advertisements based on the individualized advertisement preference, inserting the selected advertisement into the time shifted video program, and delivering the time shifted video program including the selected advertisement to the viewer. Related systems are also disclosed.

### FIELD

The present invention relates to television advertising, and in particular the present invention relates to systems/methods for delivering targeted advertisements to a television viewer over a television delivery system.

### BACKGROUND

Advertisers seek to maximize the return on their advertising expenditures by targeting their advertisements to demographic groups that are most likely to be interested in purchasing their specific products and/or services. Targeted advertising attempts to go a step further by directing advertisements to specific individuals, or types of individuals, that are expected to be interested in a specific product or service.

Targeted advertising is common on the internet. Criteria for targeting a particular internet user can be generated from a number of sources. For example, a user's online profile on a website, such as a social networking website, may contain a wealth of information about a user's age, gender, income level, interests, hobbies, etc. Such information can be used to provide advertisements to a user that are customized to that individual.

Even when such detailed information is not available, marketers can determine a significant amount of information about an individual from their online activity, for example, by tracking the individual's browsing activities, online search activities, purchasing activities, and other activities.

Highly targeted advertising, such as can be done using internet based tools, has not typically been available for advertising on more traditional media, such as cable television. Advertisements on television are typically targeted more generally to an expected demographic audience of a particular television show. However, such targeting techniques are crude at best, as the advertiser has no way of knowing who is actually watching the program and whether a given member of the audience is actually interested in his or her products/services. For example, many people watch a wide variety of programs, and it cannot be reliably assumed, for example, that only children watch children's programming, that only men watch sports, or that only women watch daytime dramas.

Moreover, because the audience cannot be narrowly defined, advertisers on television may be led to design their advertisements for a broad range of audience members, when they would otherwise design their advertisements differently if the target audience could be identified more specifically.

### SUMMARY

Methods of delivering a time shifted video program may include obtaining an individualized advertisement preference for a viewer of the time shifted video program, selecting an advertisement from among a plurality of available advertisements based on the individualized advertisement preference, inserting the selected advertisement into the time shifted video program, and delivering the time shifted video program including the selected advertisement to the viewer.

Obtaining the individualized advertisement preference may include presenting the user with a list of advertising preferences, and receiving a selection by the user of a selected advertising preference from the list of advertising preferences.

Obtaining the individualized advertisement preference may include detecting a presence of a wireless electronic device that is associated with the viewer at a location at which the time shifted video program is to be delivered, associating the wireless electronic device with a video receiver over which the time shifted video program is to be delivered, and identifying the individualized advertisement preference for the user in response to the presence of the wireless electronic device.

The methods may further include obtaining demographic information regarding the viewer in response to the presence of the wireless electronic device. Identifying the individualized advertisement preference may include identifying the individualized advertisement preference in response to the demographic information regarding the viewer.

The methods may further include confirming the identity of the viewer in response to detecting the presence of the wireless electronic device that is associated with the viewer.

Delivering the time shifted video program to the viewer may include delivering the video program to the viewer through the video receiver to a video display device. The wireless electronic device may be configured to control operations of the video receiver.

Detecting the presence of the wireless electronic device may include determining that the wireless electronic device is being used to control operations of the video receiver.

Detecting the presence of the wireless electronic device may include communicating with the wireless electronic device through a wireless communication network that is separate from a distribution network through which the time shifted video program is delivered.

The wireless electronic device may include a wireless computing device that may be configured to communicate with a wireless remote application operating in the video receiver.

The methods may further include authenticating the wireless electronic device.

The methods may further include retrieving logon credentials of the viewer for a third party demographic information storage database in response to authenticating the wireless electronic device, and obtaining demographic information relating to the viewer from the demographic information storage database using the logon credentials.

The methods may further include displaying a list of advertisement insertion points in the video program, and receiving selections from the viewer for advertisement preferences for respective ones of the advertisement insertion points.

A system for delivering a time shifted video program includes an advertisement management server configured to obtain an individualized advertisement preference for a viewer of the time shifted video program, and configured to select an advertisement from among a plurality of available advertisements based on the individualized advertisement preference, and a video distribution system configured to receive the selected advertisement from the advertisement decision server and to insert the selected advertisement into the time shifted video program, and that is further configured to deliver the time shifted video program including the selected advertisement to the viewer.

The advertisement management server may be configured to obtain the individualized advertisement preference by presenting the user with a list of advertising preferences, and receiving a selection by the user of a selected advertising preference from the list of advertising preferences.

The advertisement management server may be configured to obtain the individualized advertisement preference by detecting a presence of a wireless electronic device that is associated with the viewer at a location at which the time shifted video program is to be delivered, associating the wireless electronic device with a video receiver over which the time shifted video program is to be delivered, and identifying the individualized advertisement preference for the user in response to the presence of the wireless electronic device.

The advertisement management server may be configured to obtain the individualized advertisement preference by obtaining demographic information regarding the viewer in response to the presence of the wireless electronic device, and to identify the individualized advertisement preference in response to the demographic information regarding the viewer.

The management server may include a device to set top box mapping system that may be configured to associate the wireless electronic device with the video receiver, a user demographic and mapping system that may be configured to manage demographic information relating to the user, and an ad decision system that may be configured to select the advertisement in response to the individualized advertisement preference.

The video distribution system may include a head end unit coupled to the video receiver, the head end unit including a splicer that may be configured to insert the selected advertisement into the time shifted video program.

The advertisement management server may be configured to detect the presence of the wireless electronic device by communicating with the wireless electronic device through a wireless communication network that is separate from a distribution network through which the time shifted video program is delivered.

The advertisement management server may further be configured to retrieve logon credentials of the viewer for a third party demographic information storage database, and configured to obtain demographic information relating to the viewer from the demographic information storage database using the logon credentials.

Other systems, methods, and/or computer program products according to embodiments of the invention will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

The accompanying drawings, which are included to provide a further understanding of the invention and are incorporated in and constitute a part of this application, illustrate certain embodiment(s) of the invention. In the drawings:

FIG. 1 is a block diagram that illustrates television delivery systems according to some embodiments.

FIG. 2 is a block diagram that illustrates television delivery systems according to some embodiments in more detail.

FIG. 3 illustrates an ad selection interface that may be presented to a viewer in accordance with some embodiments.

FIG. 4 is a block diagram that illustrates a remote control device according to some embodiments.

FIG. 5 is a block diagram that illustrates an advertisement management server according to some embodiments.

FIG. 6 is a block diagram that illustrates an ad decision system according to some embodiments.

FIG. 7 is a block diagram that illustrates a back office server for a television delivery system according to some embodiments.

FIGS. 8-11 are flowcharts that illustrate operations of systems/methods according to some embodiments.

### DETAILED DESCRIPTION

Embodiments of the present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

In accordance with some embodiments, targeted advertisements may be delivered to a television viewer using a time shifted television broadcast system. In accordance with some embodiments, an individualized advertisement preference for a viewer of the time shifted video program may be obtained, and an advertisement may be selected from among a plurality of available advertisements based on the individualized advertisement preference. The system may insert the selected advertisement into the time shifted video program, and deliver the time shifted video program including the selected advertisement to the viewer. In this manner, a television advertiser can provide an advertisement to a television viewer in a highly targeted manner not previously available to television advertisers.

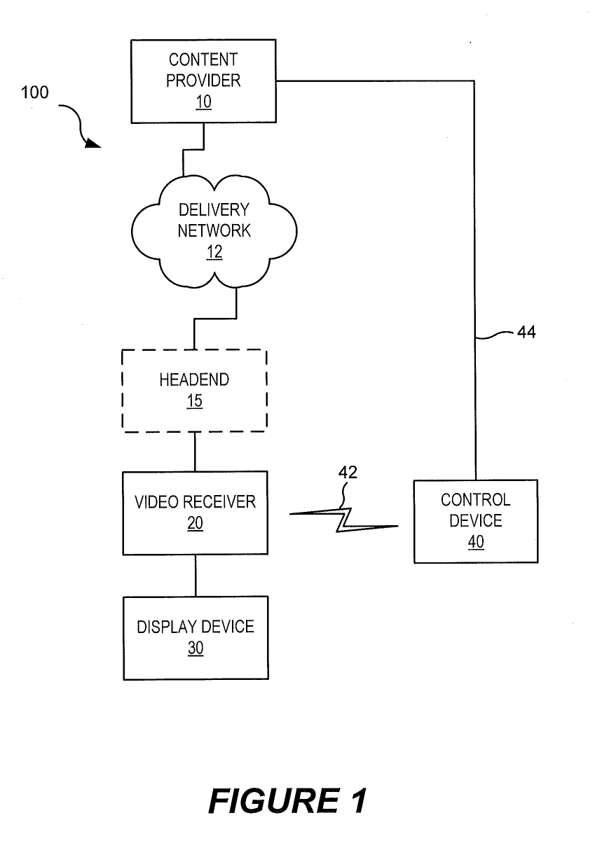

FIG. 1 is a block diagram that illustrates a general television delivery system 100 according to some embodiments. As illustrated in FIG. 1, the television delivery system 100 includes a content provider 10 that generates and transmits television programming signals over a delivery network 12. The delivery network 12 may include, for example, a cable television delivery network, a fiber-optic based television delivery network, a satellite television delivery network, a wireless local loop (“WLL”) delivery network or any other suitable television delivery network.

An optional headend unit 15 may receive the television programming signals and routes the television programming signals to local video receivers 20. For example, the headend unit 15 may serve a neighborhood, apartment complex, or other geographically proximate group of video receivers. In a cable television system, a headend is a facility that receives and re-transmits video over the local cable infrastructure. A cable headend unit 15 may receive the television signals from the content provider over a satellite network, a microwave link, a fiber optic link, or another high speed data link. In particular, the headend 15 may be implemented as a hybrid fiber-coax (HFC) unit that receives a signal from the content provider 10 via a fiber optic channel, demodulates the signal, and transmits it to local receivers via coaxial lines.

In some cases, a headend unit 15 may have the capability to store television programming signals for later delivery to viewers on demand, enabling such services as “look-back” in which previously shown programs can be delivered at a later date, and “start-over”, in which currently broadcast programs can be re-started.

The video receiver 20, such as a set-top box, receives the television signals from the headend unit 15 or directly from the delivery network 12, and displays the television signals on a display device 30, such as a television monitor, pursuant to control signals 42 from a remote control device 40. Typically, the remote control device 40 communicates with the video receiver using infrared (IR) communication signals.

According to some embodiments, the remote control device 40 is configured to communicate with the content provider 10 via a communication link 44. The communication link 44 may in some embodiments include an internet protocol (IP) link that is established over a data communications network, such as the Internet. However, it will be appreciated that the communication link 44 may be established in a number of ways and could, in some embodiments, be established through the video receiver 20 and over the delivery network 12.

According to some embodiments, an identity of a user of the remote control device 40 may be established, for example through authentication, and advertisements may be selected for programming delivered to the video receiver 20 based on the identity of the user of the remote control device 40 and/or explicit selections made by the user of the remote control device as described in more detail below. In this manner, highly targeted advertising may be provided over the television delivery system 100.

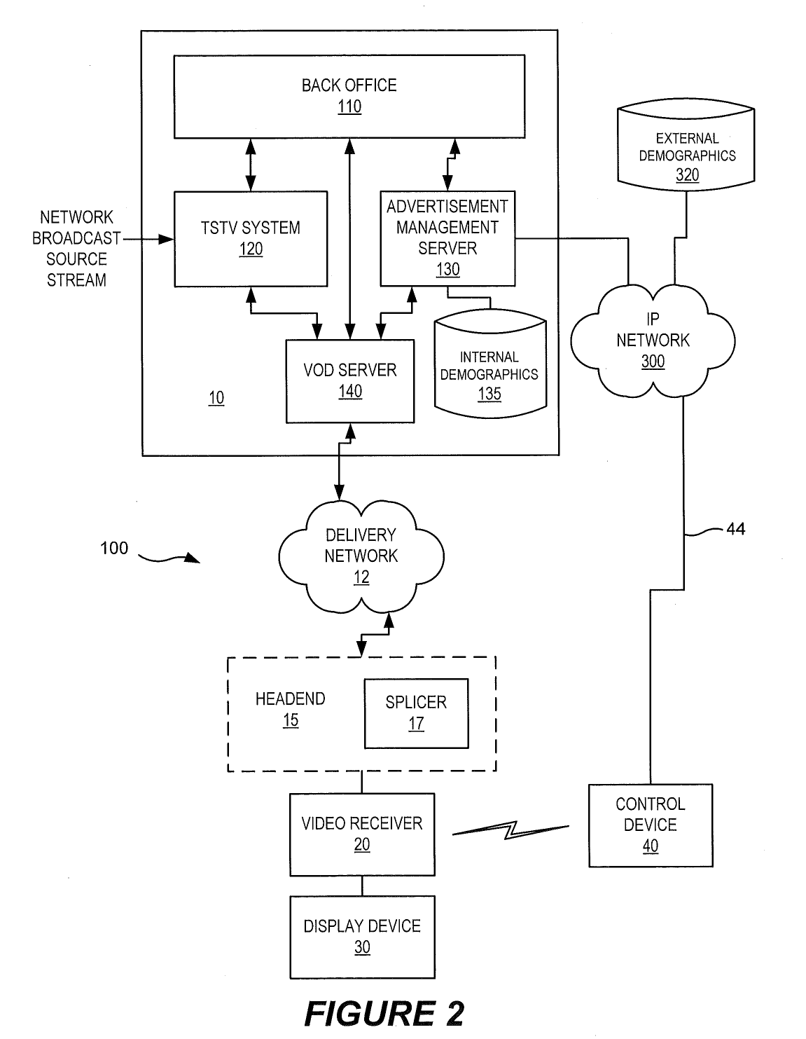

FIG. 2 is a block diagram that illustrates a television delivery system 100 according to some embodiments in more detail. As shown therein, the content provider 10 includes a back office server 110, a time shifted television (TSTV) system 120, an advertisement management server 130 and a video on demand (VOD) server 140. The ad management system accesses an internal demographics database 135 that stores demographic information relating to viewers of the television delivery system 100. Although illustrated as a separate element from the advertisement management server 130, the internal demographics database 135 can be implemented within the advertisement management server 130. Alternatively, the internal demographics database 135 can be implemented remotely from the content provider 10 and the advertisement management server 130, and can be accessed remotely by the advertisement management server 130, for example, over an IP based connection.

The advertisement management server 130 may also access an external demographics database 320 that can store demographic information relating to users of the television delivery system 100 via an IP network 300. The external demographics database 320 can be associated, for example, with an internet service, such as a social networking service, that stores information about a user's demographics, their interests, hobbies, likes and dislikes, etc.

The advertisement management server 130 may communicate with the remote control device 40 via the IP network 300. For example, the remote control device 40 can be configured for internet access through a nearby Wifi connection. In some embodiments, the video receiver 20 may be configured to act as a Wifi gateway and/or wireless node that is coupled to the IP network 300 via a cable modem connection, and the remote control device 40 may be configured to connect to the IP network 330 through the video receiver 20. Accordingly, the IP connection 44 from the remote control device 40 to the IP network 300 is illustrated as a separate connection only for ease of illustrate and to facilitate understanding.

A network broadcast source stream is received by the TSTV system 120 of the content provider 10 and delivered to the delivery network 12 through the VOD server 140. It will be appreciated that some of the functions of the TSTV system 120 and/or the VOD server can be provided in the headend unit 15.

The AMS 130 may communicate with the VOD server 140 and/or the TSTV system 120 using a lightweight stream control protocol (LSCP). Similarly, the VOD server may communicate with the headend 15 using an LSCP protocol, while providing programming to the headend 15 using a MPEG-2 transport stream. MPEG-2 may also be used to communicate the programming to the video receiver 20.

The AMS 130 may communicate with the back office 110 using, for example, a common object request broker architecture (CORBA) implemented over a hypertext transport protocol (HTTP) or real time streaming protocol (RTSP) interface.

The advertisement management server 130 is configured to obtain an individualized advertisement preference for a viewer of the video receiver 20, and is configured to select an advertisement from among a plurality of available advertisements based on the individualized advertisement preference. The selected advertisement is provided to the VOD server 140, which inserts the selected advertisement into a time shifted video program, and delivers the time shifted video program including the selected advertisement to the viewer via the delivery network 12 at a time specified by the viewer.

The advertisement management server 130 may be configured to obtain the individualized advertisement preference by presenting the user with a list of advertising preferences, and receiving a selection by the user of a selected advertising preference from the list of advertising preferences. For example, the advertisement management server 130 may present an interactive menu to the viewer over the delivery network 12, and allow the viewer to select the types of advertisements they would like to view. The user preference can be stored by the AMS 130, and can be used to select an advertisement from among a plurality of advertisements for delivery to the viewer in a time shifted television or video on demand service.

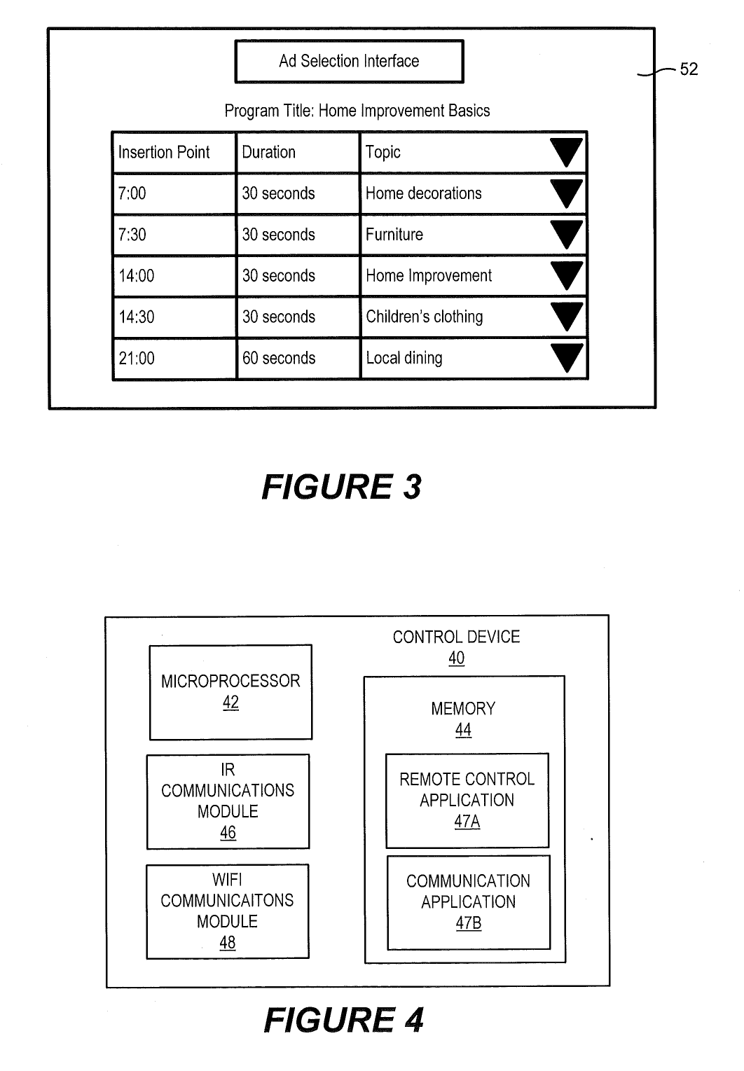

In some embodiments, a list of advertisement insertion points (“ad slots”) in the video program may be displayed to the viewer, and the AMS 130 may receive selections from the viewer for advertisement preferences for respective ones of the advertisement insertion points. For example, a screen 52 as shown in FIG. 3 may be presented to the viewer on the remote control device 40 and/or on the display device 20. On the screen 52 is an ad selection interface showing various ad insertion points for a selected program (“Home Improvement Basics”). The ad selection interface indicates the times of the insertion points in the program and the durations of the ad insertion points. The viewer may select an advertisement genre or topic for each of the ad insertion points, for example, from a plurality of drop-down lists on the screen 52. In this example, the viewer has selected to view an advertisement relating to home decorations in a first 30-second ad slot, an ad relating to furniture in the second 30-second ad slot, etc.

Time shifted television or video on demand may be useful for presenting highly targeted advertisements as described above, because unlike live broadcast television, the VOD server 140 and/or the AMS 130 may have explicit a priori knowledge of the insertion points and durations of commercial slots within a video program. Thus, the AMS 130 can select advertisements that are customized to the viewer, and the advertisements can be inserted into a video program prior to delivery of the video program to the viewer.

In some embodiments, the headend unit 15 can include a splicer 17 that is configured to insert the selected advertisement into the time shifted video program. Thus, the selected advertisement may be transmitted to the headend unit 15 prior to insertion into the video program. In some embodiments, a plurality of advertisements may be stored in advance at the headend 15, and the AMS 130 may instruct the headend 15 to insert a particular advertisement at a particular location in the video program.

In other embodiments, the splicer 17 may be located in the VOD server 140 or elsewhere within the video distribution system 100.

In some embodiments, the advertisement management server 130 may be configured to obtain the individualized advertisement preference by detecting a presence of a wireless electronic device that is associated with the viewer at a location at which the time shifted video program is to be delivered, such as the remote control device 40. The remote control device 40 can be a conventional remote control device and/or may include a personal digital assistant (PDA), laptop computer, tablet computer, or other communication device that is configured to control operations of the video receiver 20. The AMS 130 may associate the remote control device 40 by detecting the use of the remote control device to operate the video receiver 20.

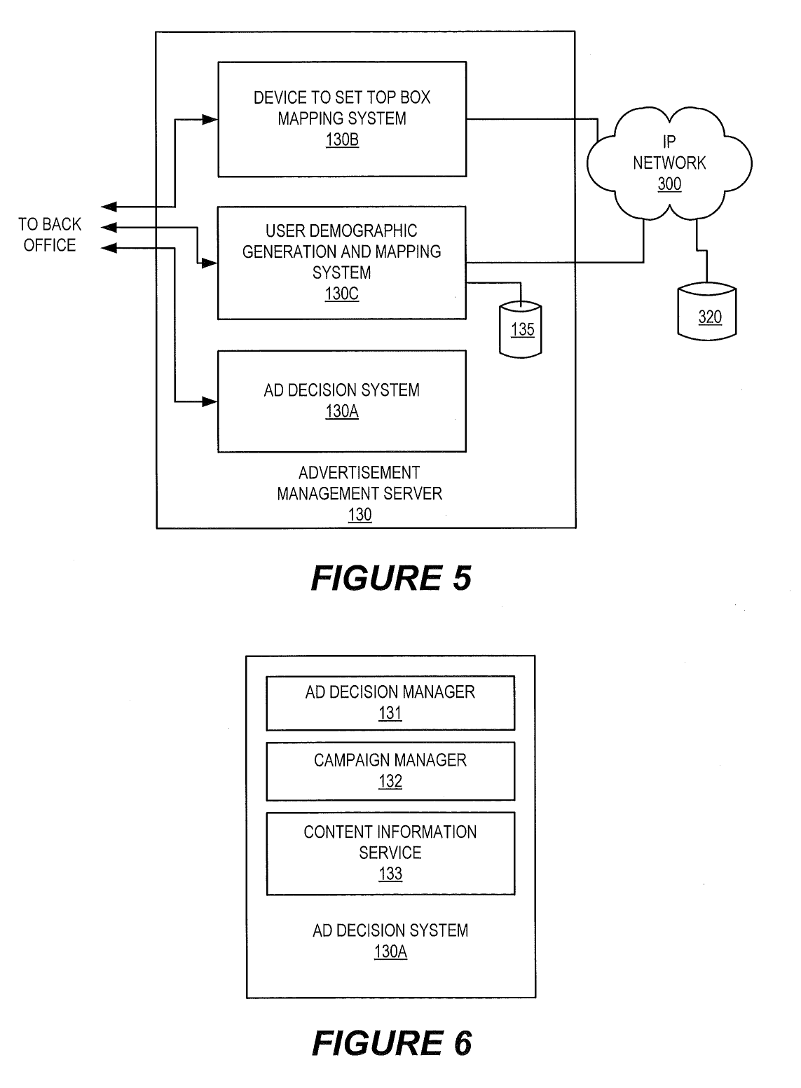

FIG. 4 is a block diagram of a remote control device 40. The remote control device 40 may include a microprocessor for controlling functions of the remote control device 40, a memory 44 coupled to the microprocessor for storing programs and/or data, an IR communications module 46 for communicating with the video receiver 20, and a Wifi module 48 for communicating with the IP network 300.

A remote control application 47A and a communications application 47B may be resident in the memory 44. The communications application 47B may detect when the remote control application 47A is being used to control operations of the video receiver 20, and may contact the AMS server 130 to notify the AMS server 130 that the remote control device 40 is being used to control operations of the video receiver 20.

In response, the AMS 130 may associate the wireless electronic device (i.e., the remote control device 40) with the video receiver 20 over which the time shifted video program is to be delivered, and may identify the individualized advertisement preference for the user.

In some embodiments, the identity of the viewer may be confirmed by the AMS 130. For example, the viewer may be prompted with an on-screen prompt to confirm his or her identity. In some embodiments, the remote control device 40 may be authenticated to the AMS 130 by means of logon credentials, a key code or other means.

The advertisement management server 130 may obtain the individualized advertisement preference by obtaining demographic information regarding the viewer based on the knowledge that a particular viewer is using the remote control device 40. Using that demographic information, the AMS 130 may identify the individualized advertisement preference.

In some embodiments, the advertisement management server 130 may be configured to retrieve logon credentials of the viewer for a third party demographic information storage database, such as the external demographics database 320, and to obtain demographic information relating to the viewer from the demographic information storage database 320 using the logon credentials. Thus, demographic information can be obtained from third party providers, such as social networking services, in some embodiments.

As an example, based on demographic information contained in the internal demographic database 135, the AMS 130 may be aware that a particular viewer is a 35 year old female who has purchased a family entertainment package from the television service, and who primarily watches home improvement related channels. Further, the AMS 130 may have a registration record associating the viewer with a smart phone used by the viewer that has remote control capabilities through a remote control application 47A. When the viewer uses the smart phone to control her video receiver 20, a communications application 47B (which may be the same as the remote control application 47A) contacts the AMS 130 via the communication link 44 and informs the AMS 130 that the user is currently operating the video receiver 20.

In response, the AMS 130 may retrieve a record of demographic information for the viewer from the internal demographic database 135 and compare the demographic information in the record to desired target demographics for available advertisements. The AMS 130 may then select one or more advertisements for insertion into the video program being played over the video receiver 20 based on the demographic information of the viewer. In this example, the AMS 130 may select one or more advertisements that the advertisers have indicated would appeal to female homeowners with children.

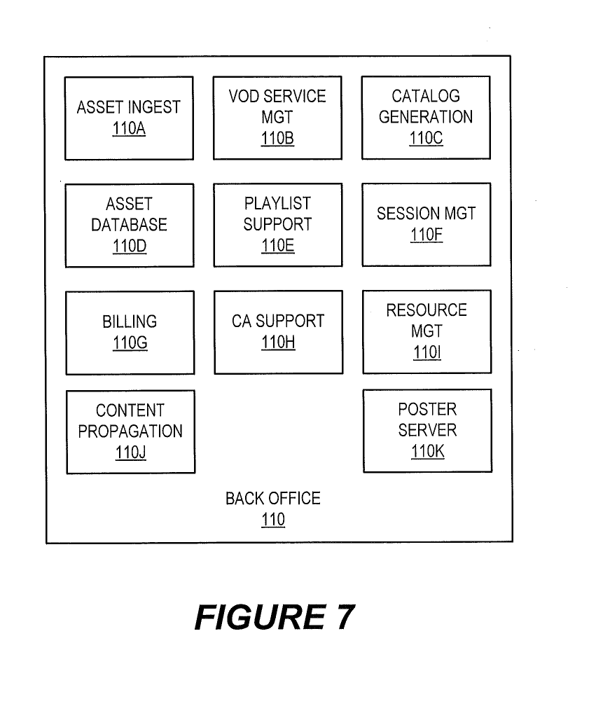

FIG. 5 is a block diagram that illustrates an advertisement management server 130 according to some embodiments in greater detail.

The AMS 130 may include an ad decision system 130A, a device to set top box mapping system 130B, and a user demographic generation and mapping system 130C. The device to set top box mapping system 130B is configured to associate the remote control device 40 with the video receiver 20. The device to set top box mapping system 130B may store a database of records of video receivers 20 that are authorized to operate with the television delivery system 100 and remote control devices used by viewers of the television delivery system 100. When the remote control device 40 contacts the AMS 130 as described above, the device to set top box mapping system 130B may retrieve a record associated with the remote control device 40 and identify the associated vide receiver 20, so that a selected advertisement can be delivered to the appropriate video receiver 20.

The user demographic generation and mapping system 130C is configured to manage demographic information relating to the user. In particular, the user demographic generation and mapping system 130C collects and stores user demographic information in the internal demographic database 135, and correlates stored user demographic information with particular viewers. The ad decision system 130A is configured to select an advertisement from among a pool of available advertisements in response to individualized advertisement preferences derived from demographic information obtained from the user demographic generation and mapping system 130C.

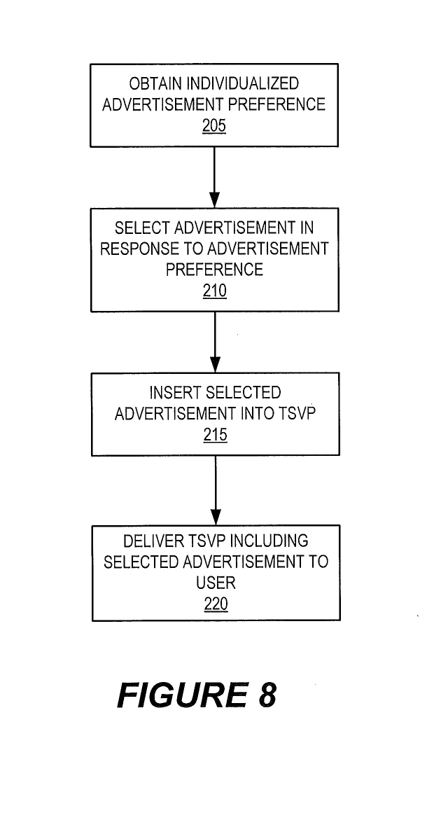

FIG. 6 is a block diagram that illustrates an ad decision system 130A according to some embodiments in greater detail. The ad decision system 130A includes an ad decision manager 131, a campaign manager 132 and a content information service (CIS) 133. The CIS 133 manages information regarding the content that is available through the VOD server 140. The campaign manager 132 manages an advertising campaign for the viewer. In particular, the campaign manager may keep track of what types of advertisements the user typically requests, may build lists of genre options to display to the viewer based on the viewer's preferences or previous selections, and/or may keep track of what advertisements have been shown to the viewer so that the viewer can be presented with a variety of different advertisements within a particular genre. The ad decision manager 131 is the function that makes the final decision on what advertisement to select for a particular slot based on input from the CIS 133 and the campaign manager 132.

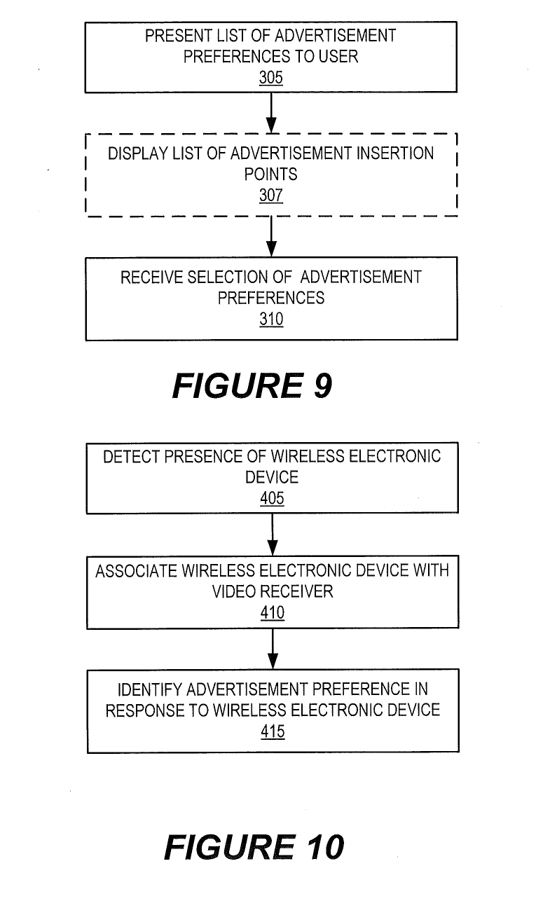

FIG. 7 is a block diagram that illustrates a back office server 110 for a television delivery system according to some embodiments. The back office server 110 provides management, control, billing and other support for the television delivery system 100. As illustrated in FIG. 7, the back office server 110 may include an asset ingest module 110A, a VOD service management module 110B, a catalog generation module 110C, an asset database 110D, a playlist support module 110E, a session management module 110F, a billing module 110G, a CA support module 110H, a resource management module 110I, a content propagation module 110J, and/or a poster server 110K. Operation of various aspects of a back office server 110 of a content provider 10 are well known in the art and need not be described further.

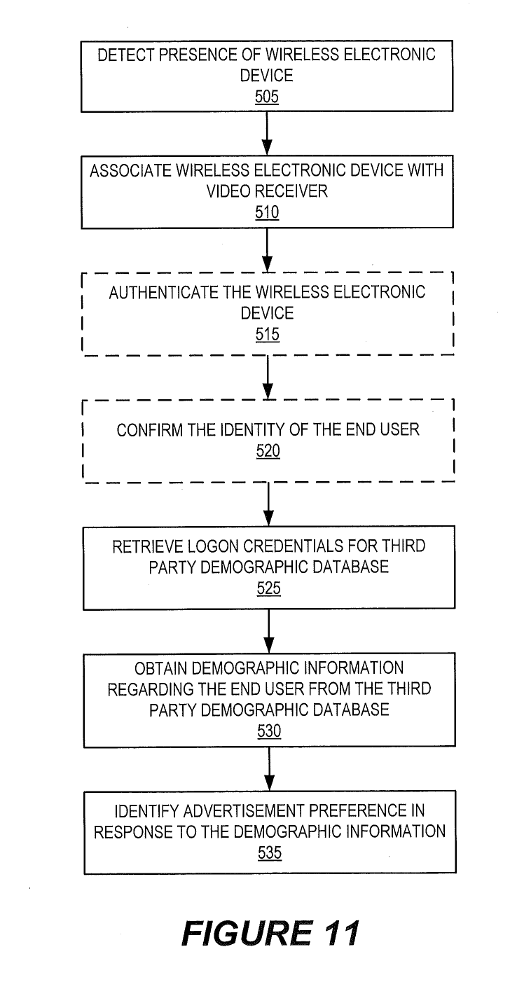

FIGS. 8-11 are flowcharts that illustrate operations of systems/methods according to some embodiments.

Referring to FIG. 8, methods of delivering a time shifted video program according to some embodiments include obtaining an individualized advertisement preference for a viewer of the time shifted video program (Block 205), selecting an advertisement from among a plurality of available advertisements based on the individualized advertisement preference (Block 210), inserting the selected advertisement into the time shifted video program (Block 215), and delivering the time shifted video program including the selected advertisement to the viewer (Block 220).

Referring to FIG. 9, in some embodiments, obtaining the individualized advertisement reference may include presenting the user with a list of advertising preferences (Block 305). The user may also optionally be presented with a list of advertisement insertion points in a selected program (Block 307). The methods further include receiving a selection by the user of a selected advertising preference from the list of advertising preferences (Block 310). In some embodiments, advertising preferences may be selected for individual ones of the advertisement insertion points.

Referring to FIG. 10, in some embodiments, obtaining the individualized advertisement preference may include detecting a presence of a wireless electronic device that is associated with the viewer at a location at which the time shifted video program is to be delivered (Block 405), associating the wireless electronic device with a video receiver over which the time shifted video program is to be delivered (Block 410), and identifying the individualized advertisement preference for the user in response to the presence of the wireless electronic device (Block 415).

Referring to FIG. 11, in some embodiments, obtaining the individualized advertisement preference may include detecting a presence of a wireless electronic device that is associated with the viewer at a location at which the time shifted video program is to be delivered (Block 505), and associating the wireless electronic device with a video receiver over which the time shifted video program is to be delivered (Block 510). Optionally, the wireless electronic device may be authenticated (Block 515) and/or the identity of the user of the wireless electronic device can be confirmed, for example, through a passcode or logon dialog (Block 520).

Logon credentials for a third party demographic information storage database may be retrieved (Block 525), and demographic information relating to the viewer may be obtained from the third party demographic information storage database (Block 530). The individualized advertisement preference for the user may be identified in response to the demographic information (Block 535).

Some embodiments of the invention are based on the pairing of smart devices, such as smart phones, tablet computers, laptops, PDA's, etc., with television set-top boxes. The pairing of these devices, along with user authentication, permits a television service provider to know exactly who is watching the program, and consequently permit the television service provider to deliver highly targeted advertisements to the viewer. Accordingly, embodiments of the invention may enable better targeting of advertisements to viewers, which may increase the chances that the viewer will be interested in, and act on, information in the advertisement.

Some embodiments of the present invention are described with reference to flowchart illustrations and/or block diagrams of methods, systems and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the present invention may be written in an object oriented programming language such as Java® or C++. However, the computer program code for carrying out operations of the present invention may also be written in conventional procedural programming languages, such as the “C” programming language. The program code may execute entirely on the user's computer, partly on the user's computer, as a stand alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

In the drawings and specification, there have been disclosed typical embodiments of the invention and, although specific terms are employed, they are used in a generic and descriptive sense only and not for purposes of limitation, the scope of the invention being set forth in the following claims.

What is claimed is:

1. A method of delivering a time shifted video program, the method comprising:
obtaining an individualized advertisement preference for a viewer of the time shifted video program;
selecting an advertisement from among a plurality of available advertisements based on the individualized advertisement preference;
inserting the selected advertisement into the time shifted video program; and
delivering the time shifted video program including the selected advertisement to the viewer.

2. The method of claim 1, wherein obtaining the individualized advertisement preference comprises:
presenting the user with a list of advertising preferences; and
receiving a selection by the user of a selected advertising preference from the list of advertising preferences.

3. The method of claim 1, wherein obtaining the individualized advertisement preference comprises:
detecting a presence of a wireless electronic device that is associated with the viewer at a location at which the time shifted video program is to be delivered;
associating the wireless electronic device with a video receiver over which the time shifted video program is to be delivered; and
identifying the individualized advertisement preference for the user in response to the presence of the wireless electronic device.

4. The method of claim 3, further comprising obtaining demographic information regarding the viewer in response to the presence of the wireless electronic device, wherein identifying the individualized advertisement preference comprises identifying the individualized advertisement preference in response to the demographic information regarding the viewer.

5. The method of claim 3, further comprising:
in response to detecting the presence of the wireless electronic device that is associated with the viewer, confirming the identity of the viewer.

6. The method of claim 3, wherein delivering the time shifted video program to the viewer comprises delivering the video program to the viewer through the video receiver to a video display device, wherein the wireless electronic device is configured to control operations of the video receiver.

7. The method of claim 6, wherein detecting the presence of the wireless electronic device comprises determining that the wireless electronic device is being used to control operations of the video receiver.

8. The method of claim 6, wherein detecting the presence of the wireless electronic device comprises communicating with the wireless electronic device through a wireless communication network that is separate from a distribution network through which the time shifted video program is delivered.

9. The method of claim 6, wherein the wireless electronic device comprises a wireless computing device that is configured to communicate with a wireless remote application operating in the video receiver.

10. The method of claim 9, further comprising authenticating the wireless electronic device.

11. The method of claim 10, further comprising retrieving logon credentials of the viewer for a third party demographic information storage database in response to authenticating the wireless electronic device, and obtaining demographic information relating to the viewer from the demographic information storage database using the logon credentials.

12. The method of claim 2, further comprising:
displaying a list of advertisement insertion points in the video program; and
receiving selections from the viewer for advertisement preferences for respective ones of the advertisement insertion points.

13. A system for delivering a time shifted video program, the system comprising:
an advertisement management server configured to obtain an individualized advertisement preference for a viewer of the time shifted video program, and configured to select an advertisement from among a plurality of available advertisements based on the individualized advertisement preference; and
a video distribution system that is configured to receive the selected advertisement from the advertisement decision server and to insert the selected advertisement into the time shifted video program, and that is configured to deliver the time shifted video program including the selected advertisement to the viewer at a time specified by the viewer.

14. The system of claim 13, wherein the advertisement management server is configured to obtain the individualized advertisement preference by presenting the user with a list of advertising preferences, and receiving a selection by the user of a selected advertising preference from the list of advertising preferences.

15. The system of claim 13, wherein the advertisement management server is configured to obtain the individualized advertisement preference by detecting a presence of a wireless electronic device that is associated with the viewer at a location at which the time shifted video program is to be delivered, associating the wireless electronic device with a video receiver over which the time shifted video program is to be delivered, and identifying the individualized advertisement preference for the user in response to the presence of the wireless electronic device.

16. The system of claim 15, wherein the advertisement management server is configured to obtain the individualized advertisement preference by obtaining demographic information regarding the viewer in response to the presence of the wireless electronic device, and to identify the individualized advertisement preference in response to the demographic information regarding the viewer.

17. The system of claim 15, wherein the advertisement management server comprises a device to set top box mapping system that is configured to associate the wireless electronic device with the video receiver, a user demographic and mapping system that is configured to manage demographic information relating to the user, and an ad decision system that is configured to select the advertisement in response to the individualized advertisement preference.

18. The system of claim 17, wherein the video distribution system comprises a head end unit coupled to the video receiver, the head end unit comprising a splicer that is configured to insert the selected advertisement into the time shifted video program.

19. The system of claim 15, wherein the advertisement management server is configured to detect the presence of the wireless electronic device by communicating with the wireless electronic device through a wireless communication network that is separate from a distribution network through which the time shifted video program is delivered.

20. The system of claim 15, wherein the advertisement management server is further configured to retrieve logon credentials of the viewer for a third party demographic information storage database, and configured to obtain demographic information relating to the viewer from the demographic information storage database using the logon credentials.
